(19) United States
(12) Patent Application Publication
(10) Pub. No.: US 2006/0259624 A1
(43) Pub. Date: Nov. 16, 2006

(54) Network address transition methods and systems

(75) Inventors: Chih-Lin Hu, Tainan City (TW); Wei-E Jiang, Taipei County (TW); Wei-Nan Tseng, Taipei City (TW)

Correspondence Address: BIRCH STEWART KOLASCH & BIRCH, PO BOX 747, FALLS CHURCH, VA, 22040-0747, US

(73) Assignee: BENQ CORPORATION, Taoyuan (TW)

(21) Appl. No.: 11/398,570

(22) Filed: Apr. 6, 2006

(30) Foreign Application Priority Data
Apr. 8, 2005 (TW) 94111134

(51) Int. Cl. G06F 15/173

(52) U.S. Cl. 709/226

(57) ABSTRACT

A method for network address transition. A first network address probe message is received from a second electronic device connecting to network, and the first network address probe message comprises information regarding the second electronic device attempting to select an address in the second subnet to serve as its network address. A server response function utilized to reply to a request message from one first electronic device is disabled.

### BACKGROUND

The present invention relates to network address handling, and more particularly, to network address transition methods and systems.

An increasing amount of digital media on various devices, such as consumer electronics (CEs), mobile devices and personal computers (PCs) are acquired, viewed and managed by users. The vision of the “digital home” combines the Internet, mobile and broadcast networks into a seamless, interoperable network. To realize this vision, the DLNA (Digital Living Network Alliance) has developed a framework for interoperable product design. The DLNA interoperability guideline is typically used to build interoperable networked platforms and devices for the digital home. Under the guidelines, six functional components have been defined for devices and software infrastructure as well as their technology components: physical media, network transport, media transport, device discovery and control, media management and control, and media formats.

UPnP Forum has developed a UpnP Device Architecture for pervasive peer-to-peer network connectivity of devices. UPnP technology is recognized under the DLNA interoperability guidelines. Its design provides a distributed, open networking architecture that leverages TCP/IP and Web technologies to enable seamless proximity networking, control and data transfer to ad-hoc or unmanaged networks whether in the home, in a small business, or attached to the Internet. UPnP technology defines a series of communication protocols used for UPnP network addressing, discovery, description, control, eventing and presentation. Two general device classifications are defined by the UPnP architecture: controlled devices and control points.

The foundation for UPnP networking is Internet Protocol (IP) addressing. The IP suite is independent of physical media and capable of tying networked devices together within the home, thereby providing the underlying network communications for applications and enabling connectivity outside the home to the global Internet. Specifically, each DLNA device or UPnP device, which are used interchangeable terms throughout this specification, must have a DHCP client and search for a DHCP server when the device is first connected to the network. If a DHCP server is available, i.e., the network is managed, the device must use the IP address assigned thereto. If no DHCP server is available, i.e., the network is unmanaged; the device must use auto-IP addressing to obtain an address.

Communication between some devices will no longer be possible any more because two types of IP addresses typically belong to different subnets. When two devices share the same link but use IP addresses in different subnets, the IP stack (particularly subnet masking) rejects any packet coming from an IP address not on the same subnet except for multicast addresses.

### SUMMARY

Methods for network address transition are provided. A server assigns multiple addresses in a first subnet to multiple first electronic devices to serve as their network addresses. The first electronic devices and a second electronic device store multiple addresses in a second subnet. An embodiment of a network address transition method performed by the server, comprises the following steps. A first network address probe message is received from the second electronic device recently connected to a network. The message comprises information regarding the attempt by second electronic device to select an address in the second subnet to serve as its network address. A response function for replying with a request message from one of the first electronic devices is disabled. The request message may be a server discovery message for detecting whether a network address management server is present, a network address request message utilized to acquire a new address in the first subnet, or a network address management server query message utilized to detect whether the server is available. The server discovery message is preferably a DHCPDISCOVERY message compatible with the dynamic host configuration protocol (DHCP) standard, the network address request message is preferably a DHCPQUEST message compatible with the DHCP standard, and the network address management server query message is preferably a DHCPINFO message compatible with the DHCP standard. The server is preferably a DHCP server. The network address probe message is preferably an address resolution protocol (ARP) probe message compatible with the ARP standard.

The server may store the addresses in the first subnet. An embodiment of a network address transition method may further comprise the following steps. A server discovery message utilized to detect whether a network address management server is present is received from the second electronic device. The addresses in the first subnet are assigned to the first electronic devices. All first electronic devices are queried after receiving the server discovery message. A portion of the addresses in the first subnet used by a portion of first electronic devices which do not respond to queries are reclaimed.

The server may store the addresses in the first subnet. An embodiment of a network address transition method may further comprise the following steps. A server discovery message utilized to detect whether a network address management server is present is received from the second electronic device. It is determined that no available address in the first subnet can be assigned to the second electronic device. The server discovery message is ignored, or a discovery rejection message rejecting the server discovery message is replied. The server discovery message is preferably a DHCPNAK message compatible with the DHCP standard. The first network address probe message is transmitted during an automatic address configuration procedure performed by the second electronic device, and the automatic address configuration procedure is activated after the second electronic device transmits the server discovery message and does not receive any server offer messages for a period of time.

An embodiment of a network address transition method may further comprise the following steps. Multiple network address renew messages are transmitted to the first electronic devices. The network address renew messages are utilized to force the first electronic devices to acquire new addresses in the first subnet.

An embodiment of a network address transition method may further comprise the following steps. A second network address probe message comprising information regarding the attempt by one of the first electronic devices to select an address in the second subnet to serve as its network address is received. The second network address probe message is transmitted from one of the first electronic devices when the server does not reply to the request message.

A machine-readable storage medium storing a computer program which, when executed by the server, performs the method of network address transition is also disclosed.

Servers for network address transition are provided. An embodiment of a server, connecting to multiple first electronic devices and a second electronic device via a network, comprises a storage module, an allocation module, a response module and a control module. The first electronic devices and the second electronic device store multiple addresses in a second subnet. The storage module stores multiple addresses in a first subnet. The allocation module assigns the stored addresses in the first subnet to the first electronic devices to serve as their network addresses. The response module replies messages from one of the first electronic devices and second electronic device. The control module receives a first network address probe message from the second electronic devices, and, when there is no available address in the first subnet stored in the storage module, disables the response module, thereby directing communications between the first electronic devices and the second electronic device using addresses in the second subnet.

The second electronic device may transmit a server discovery message utilized to detect whether a network is address management server is present to the server. The control module may assign the addresses in the first subnet to the first electronic devices, query all first electronic devices after receiving the server discovery message, and reclaims a portion of the addresses in the first subnet used by a portion of first electronic devices which do not respond to queries. The control module may ignore the server discovery message or reply to a discovery rejection message. The first network address probe message may be transmitted during an automatic address configuration procedure performed by the second electronic device, and the automatic address configuration procedure may be activated after the second electronic device transmits the server discovery message and does not receive any server offer messages for a period of time.

The control module may transmit multiple network address renew messages to the first electronic devices. The network address renew messages may be utilized to force the first electronic devices to acquire new addresses in the first subnet to serve as their network addresses. The control module may receive a second network address probe message comprising information regarding one of the first electronic devices attempting to select an address in the second subnet to serve as its network address. The second network address probe message may be transmitted from one of the first electronic devices when the server does not reply to the request message.

### DESCRIPTION OF THE DRAWINGS

The invention will become more fully understood by referring to the following detailed description of embodiments with reference to the accompanying drawings, wherein:

FIG. 1 is a diagram of network architecture of an embodiment of a network address transition system;

FIG. 2 is a diagram of a hardware environment applicable to an embodiment of a network address management server or a personal computer;

FIG. 3 is a diagram of a hardware environment applicable to an embodiment of a mobile device;

FIG. 4 is a diagram of system architecture of an embodiment of a Liquid Crystal Display (LCD) apparatus;

FIGS. 5, 6 and 7 illustrate flowcharts of network address transition methods;

FIG. 8 is a diagram of a storage medium storing a computer program for network address transition;

FIG. 9 is a diagram of software modules applicable in an embodiment of a network address management server.

### DETAILED DESCRIPTION

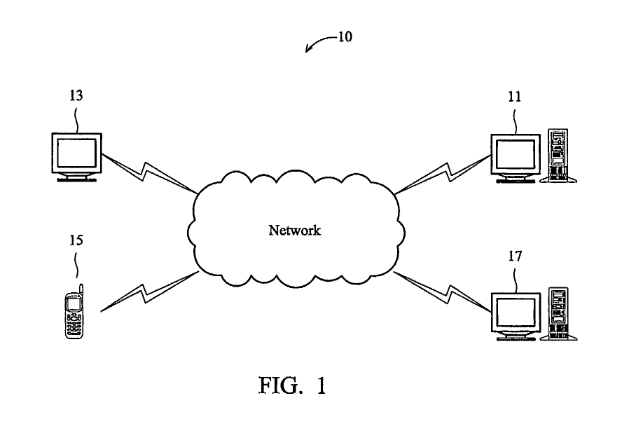

FIG. 1 is a diagram of network architecture of an embodiment of a network address transition system 10, comprising a network address management server 11, display apparatus 13, mobile device 15 and personal computer 17. The display apparatus 13, mobile device 15 and personal computer 17 operate in a network using wired, wireless or a combination thereof to connect to the network address management server 11. The network address management server 11 is preferably a DHCP (Dynamic Host Configuration Protocol) server. Those skilled in the art will recognize that the network address management server 11, display apparatus 13, mobile device 15 and personal computer 17 may be connected in different types of networking environments, and communicate therebetween through various types of transmission devices such as routers, gateways, access points, base station systems or others. The display apparatus 13, mobile device 15 and personal computer 17 are preferably compatible with DLNA (Digital Living Network Alliance) guidelines. The display apparatus 13, mobile device 15 and personal computer 17 may have DHCP clients to search for a DHCP server when they are first connected to the network.

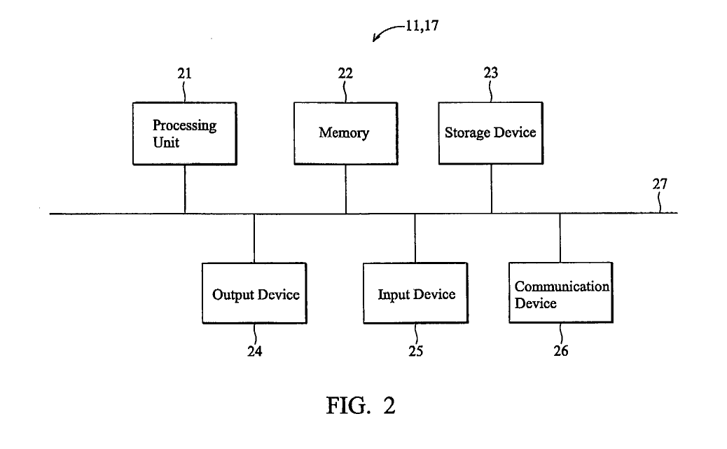

FIG. 2 is a diagram of a hardware environment applicable to an embodiment of the network address management server 11 or personal computer 17, comprising a processing unit 21, memory 22, a storage device 23, an output device 24, an input device 25 and a communication device 26. The processing unit 21 is connected by buses 27 to the memory 22, storage device 23, output device 24, input device 25 and communication device 26 based on Von Neumann architecture. There may be one or more processing units 11, such that the processor of the computer comprises a single central processing unit (CPU), a microprocessing unit (MPU) or multiple processing units, commonly referred to as a parallel processing environment. The memory 22 is preferably a random access memory (RAM), but may also include read-only memory (ROM) or flash ROM. The memory 22 preferably stores program modules executed by the processing unit 21 to perform message compression functions. Generally, program modules include routines, programs, objects, components, or others, that perform particular tasks or implement particular abstract data types. Moreover, those skilled in the art will understand that some embodiments may be practiced with other computer system configurations, including handheld devices, multiprocessor-based, microprocessor-based or programmable consumer electronics, network PCs, minicomputers, mainframe computers, and the like. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web objects, Web Services or other similar architectures. The storage device 23 may be a hard drive, magnetic drive, optical drive, portable drive, or nonvolatile memory drive. The drives and associated computer-readable media thereof (if required) provide nonvolatile storage of computer-readable instructions, data structures and program modules. The communication device 26 may be a wired network adapter or a wireless network adapter compatible with GPRS, 802.x, Bluetooth and the like.

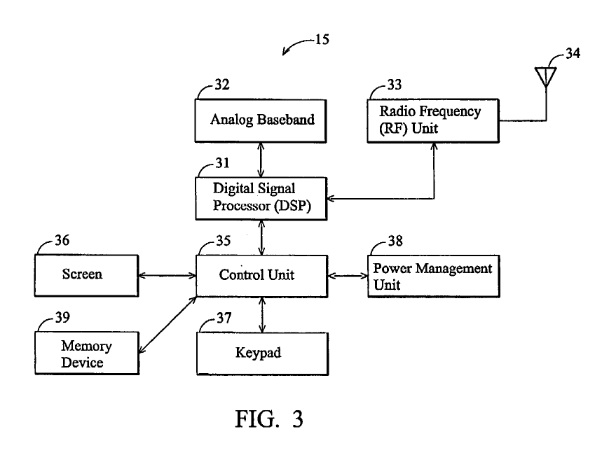

FIG. 3 is a diagram of a hardware environment applicable to an embodiment of the mobile device 15 comprising a digital signal processor (DSP) 31, an analog baseband 32, a radio frequency (RF) unit 33, an antenna 34, a control unit 35, a screen 36, a keypad 37, a power management unit 38 and a memory device 39. Moreover, those skilled in the art will understand that some embodiments may be practiced with other embedded system devices, including digital personal assistant (PDA), digital music player, portable disk drive, programmable consumer electronics, and the like. The memory device 39 is preferably a random access memory (RAM), but may also include read-only memory (ROM) or flash ROM, storing program modules loaded and executed by the control unit 35 to perform network address transition functions.

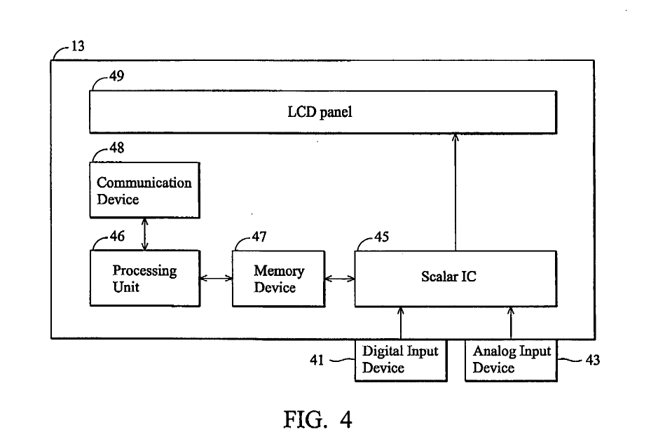

FIG. 4 is a diagram of the system architecture of an embodiment of a liquid crystal display (LCD) apparatus. A LCD apparatus 13 comprises a digital input device 41, an analog input device 43, a scalar IC 45, a processing unit 46, a memory device 47, a communication device 48 and a LCD panel 49. Moreover, those skilled in the art will understand that some embodiments may be practiced with other display configurations, including cathode ray tube (CRT), plasma display panel (PDP), organic light-emitting diode (OLED) displays, and the like. The memory device 47, such as random access memory (RAM), read-only memory (ROM), flash ROM, and the like, stores program modules executed by the processing unit 46 to perform network address transition.

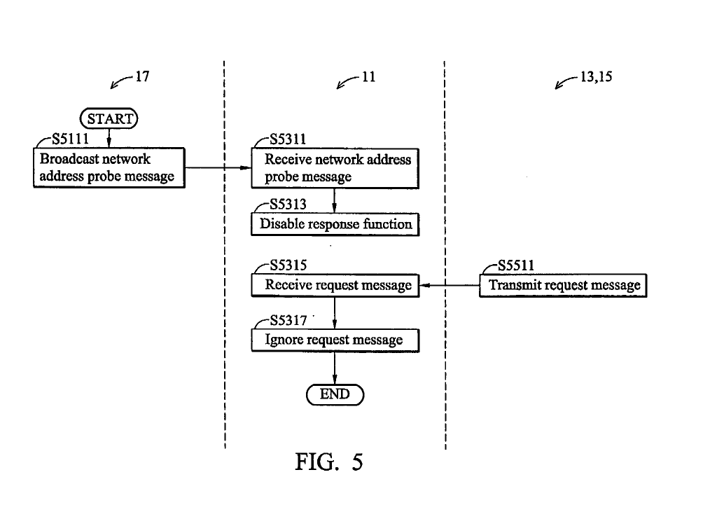

FIG. 5 illustrates a flowchart of an embodiment of a method for network address transition, divided into three sections, a left section showing steps performed by the personal computer 17, a middle section showing steps performed by the network address management server 11, and a right section showing steps performed by the display apparatus 13 or mobile device 15, separated by dashed lines for added clarity. The network addresses in two subnets, such as 192.192.1.x and 203.62.x.x, can be configured as client device addresses. The network address management server 11 stores addresses in the subnet 192.192.1.x and assigns one of them to the display apparatus 13, mobile device 15 or personal computer 17. The display apparatus 13 or mobile device 15 acquires an address in the subnet 192.192.1.x (i.e. D-address) as its network address. The personal computer 17, recently connected to the network, attempts to acquire an available address as its network address.

In step S5111, a network address probe message comprising an address in the subnet 203.62.x.x (i.e. A-address) is broadcast. The network address probe message is utilized to ask whether the supplied address conflicts with an address used by a client device.

In step S5311, the network address probe message is received by the network address management server 11. In step S5313, the response function is disabled. When the response function is disabled, a request message transmitted from the display apparatus 13 or mobile device 15 is ignored.

In step S5511, a request message is transmitted by the display apparatus 13 or mobile device 15. In step S5313, the request message is received by the network address management server 11. In step S5317, the request message is ignored because response function is disabled.

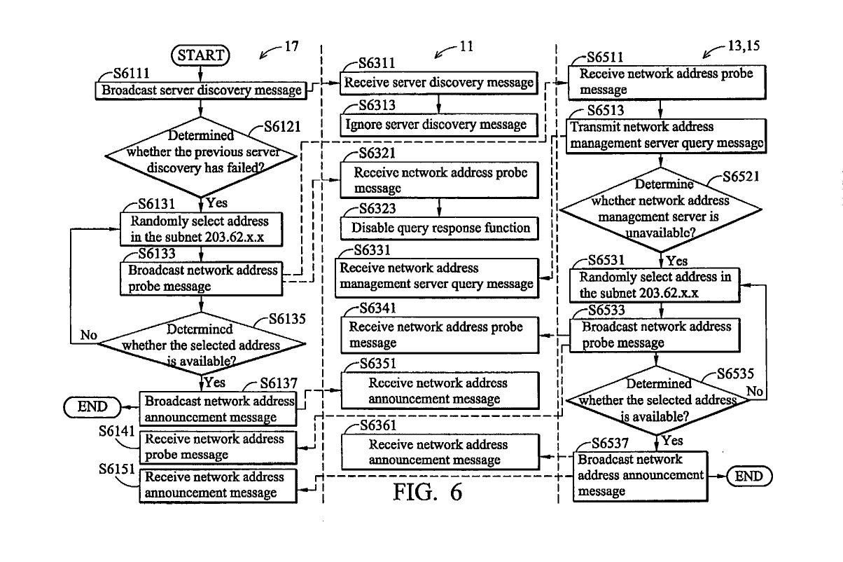

FIG. 6 illustrates a flowchart of an embodiment of a method for network address transition, divided into three sections, a left section showing steps performed by the personal computer 17, a middle section showing steps performed by the network address management server 11, and a right section showing steps performed by the display apparatus 13 or mobile device 15, separated by dashed lines for added clarity. Network addresses in two subnets, such as 192.192.1.x and 203.62.x.x, can be configured as client device addresses. The network address management server 11 assigns stored addresses in the subnet 192.192.1.x to client devices, such as the display apparatus 13, mobile device 15 or personal computer 17, which attempt to connect to the network. The display apparatus 13 or mobile device 15 has acquired an address in the subnet 192.192.1.x (i.e. D-address) as its network address. The personal computer 17 initiates a network function to connect to the network and attempts to acquire an available address as its network address.

In step S6111, a server discovery message is broadcast by the personal computer 17 to detect whether a network address management server is present. The server discovery message is preferably a DHCPDISCOVER message compatible with the DHCP standard. The personal computer 17 will ideally receive a server offer message indicating that a network address management server is present on the network. The server offer message is preferably a DHCPOFFER message compatible with the DHCP standard. In step S6311, a server discovery message is received by the network address management server 11. In step S6313, when all stored addresses in the subnet 192.192.1.x have been assigned or cannot be assigned for certain reasons, the received server discovery message is ignored. And alternately, a discovery rejection message is returned to the personal computer 17. The discovery rejection message is preferably a DHCPNAK message compatible with the DHCP standard.

In step S6121, it is determined whether the previous server discovery by the personal computer 17 has failed, and, if so, the process proceeds to step S6131. In this step, if the personal computer 17 does not receive any server offer messages after a time-out expires, it may retransmit the server discovery message (at most in finite retransmission times). After one or multiple retransmissions fail to receive any server offer messages, it is determined that the previous server discovery by the personal computer 17 has failed. And alternately, it is determined the previous server discovery is failure by the personal computer 17 when a discovery rejection message is received.

An automatic address configuration procedure proceeding from steps S6131 to S6137 is performed by the personal computer 17. In step S6131, an address in the subnet 203.62.x.x (i.e. A-address), preferably an Internet Protocol (IP) address, is randomly selected by the personal computer 17. The addresses in the subnet 203.62.x.x are stored in the personal computer 17, display apparatus 13 and mobile device 15 to facilitate execution of the automatic address configuration procedure. In order to provide the connections required by a large number of client devices, the number of stored addresses may be greater than the number of addresses assignable by the network address management server 11. In step S6133, a network address probe message comprising the selected address is broadcast to ask whether the supplied address conflicts with an address used by a client device. The network address probe message is preferably an Address Resolution Protocol (ARP) probe message compatible with the ARP standard. The personal computer 17 will ideally not receive a network address conflict message, and otherwise, if the supplied address conflicts with an address used by a client device, the personal computer 17 will receive a network address conflict message. In step S6135, it is determined whether the selected address is available, and, if so, the process proceeds to step S6137, and otherwise, to step S6131. In step S6135, the personal computer 17 receives no network address conflict message after a time-out expires, and determines that the selected address is available. Conversely, the personal computer 17 receives no network address conflict message after a time-out expires, and then retransmits the network address probe message (at most in finite retransmission times). After one or multiple retransmissions fail to receive any network address conflict messages, it is determined that the selected address is available by the personal computer 17. In step S6137, a network address announcement message comprising the selected address is broadcast to notify all server and client devices that the supplied address (i.e. A-address) is used to serve as its network address. The network address announcement message is preferably an ARP announcement message compatible with the ARP standard.

In step S6321, the network address probe message is received by the network address management server 11. In step S6323, the query response function is disabled. When the query response function is disabled, network address management server query messages transmitted from any client devices will be ignored (i.e. network address management server acknowledge messages are not sent).

In step S6511, a network address probe message is received by the display apparatus 13 or mobile device 15. In step S6513, a network address management server query message is transmitted to detect whether the network address management server 11 is available. The network address management server query message is preferably a DHCPINFO message compatible with the DHCP standard. The display apparatus 13 or mobile device 15 will ideally receive a network address management server acknowledgement message. If the display apparatus 13 or mobile device 15 receives no network address management server acknowledgement message, represents that the network address management server 11 is unavailable. The network address management server acknowledgement message is preferably a DHCPACK message compatible with the DHCP standard. In step S6331, the network address management server query message is received by the network address management server 11. The received query message is ignored (i.e. do not reply a network address management server acknowledgement message) because query response function is previously disabled. In step S6521, it is determined whether the network address management server 11 is unavailable, and, if so, the process proceeds to step S6531. In step S6531, the display apparatus 13 or mobile device 15 receives no network address management server acknowledgement message after a time-out expires, and then determines that the network address management server 11 is unavailable. Conversely, the display apparatus 13 or mobile device 15 receives no network address management server acknowledgement message after a time-out expires, and then retransmits the network address management server query message (at most in finite retransmission times). After one or multiple retransmissions fail to receive any network address management server acknowledgement messages, it is determined that the network address management server 11 is unavailable by the display apparatus 13 or mobile device 15.

An automatic address configuration procedure proceeding from steps S6531 to S6537 is performed by the display apparatus 13 or mobile device 15. In step S6531, an address in the subnet 203.62.x.x (i.e. A-address), preferably an Internet Protocol (IP) address, is randomly selected by the display apparatus 13 or mobile device 15. In step S6533, a network address probe message comprising the selected address is broadcast to ask whether the supplied address conflicts with an address used by a client device. The display apparatus 13 or mobile device 15 will ideally receive no network address conflict message, and otherwise, if the supplied address conflicts with an address used by a client device, the display apparatus 13 or mobile device 15 will receive a network address conflict message. In step S6535, it is determined whether the selected address is available, and, if so, the process proceeds to step S6537, and otherwise, to step S6531. In step S6535, the display apparatus 13 or mobile device 15 receives no network address conflict message after a time-out expires, and then determines that the selected address is available. Conversely, the display apparatus 13 or mobile device 15 receives no network address conflict message after a time-out expires, and then retransmits the network address probe message (at most in finite retransmission times). After one or multiple retransmissions fail to receive any network address conflict messages, it is determined that the selected address is available by the display apparatus 13 or mobile device 15. In step S6537, a network address announcement message comprising the selected address is broadcast to notify all server and client devices that the supplied address (i.e. A-address) is used to serve as its network address.

In step S6311, the network address management server 11 may additionally transmit query messages to client devices using addresses in the subnet 192.192.1.x according to stored information to ensure whether these client devices are still available after receiving a server discovery message. The network address management server 11 reclaims addresses used by those client devices do not reply acknowledgment of query messages after a predetermined period of time, and subsequently assigns a reclaimed address to the personal computer 17. Conversely, the process proceeds to step S6313 when no assigned address can be reclaimed.

Note that all steps performed in the middle section are omitted when the network address management server 11 is not present in the network or is unavailable.

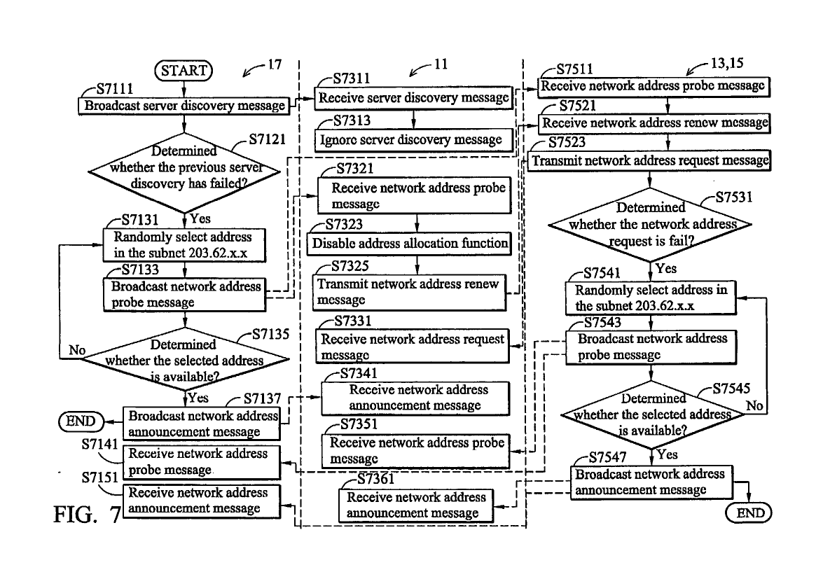

FIG. 7 illustrates a flowchart of an embodiment of a method for network address transition, divided into three sections, a left section showing steps performed by the personal computer 17, a middle section showing steps performed by the network address management server 11, and a right section showing steps performed by the display apparatus 13 or mobile device 15, separated by dashed lines for added clarity. Network addresses in two subnets, such as 192.192.1.x and 203.62.x.x, can be configured as client device addresses. The network address management server 11 assigns stored addresses in the subnet 192.192.1.x to client devices, such as the display apparatus 13, mobile device 15 or personal computer 17, which attempt to connect to the network. The display apparatus 13 or mobile device 15 has acquired an address in the subnet 192.192.1.x (i.e. D-address) as its network address. The personal computer 17 initiates a network function to connect to the network and attempts to acquire an available address as its network address.

In step S7111, a server discovery message is broadcast by the personal computer 17 to detect whether a network address management server is present. The server discovery message is preferably a DHCPDISCOVER message compatible with the DHCP standard. The personal computer 17 will ideally receive a server offer message indicating that a network address management server is present on the network. The server offer message is preferably a DHCPOFFER message compatible with the DHCP standard. In step S7311, a server discovery message is received by the network address management server 11. In step S7313, when all stored addresses in the subnet 192.192.1.x have been assigned or cannot be assigned for certain reasons, the received server discovery message is ignored. And alternately, a discovery rejection message is returned to the personal computer 17. The discovery rejection message is preferably a DHCPNAK message compatible with the DHCP standard.

In step S7121, it is determined whether the previous server discovery by the personal computer 17 has failed, and, if so, the process proceeds to step S7131. In this step, if the personal computer 17 does not receive any server offer messages after a time-out expires, it may retransmit the server discovery message (at most in finite retransmission times). After one or multiple retransmissions fail to receive any server offer messages, it is determined that the previous server discovery by the personal computer 17 has failed. And alternately, it is determined the previous server discovery is failure by the personal computer 17 when a discovery rejection message is received.

An automatic address configuration procedure proceeding from steps S7131 to S7137 is performed by the personal computer 17. In step S7131, an address in the subnet 203.62.x.x (i.e. A-address), preferably an Internet Protocol (IP) address, is randomly selected by the personal computer 17. The addresses in the subnet 203.62.x.x are stored in the personal computer 17, display apparatus 13 and mobile device 15 to facilitate execution of the automatic address configuration procedure. In order to provide the connections required by a large number of client devices, the number of stored addresses may be greater than the number of addresses assignable by the network address management server 11. In step S7133, a network address probe message comprising the selected address is broadcast to ask whether the supplied address conflicts with an address used by a client device. The network address probe message is preferably an Address Resolution Protocol (ARP) probe message compatible with the ARP standard. The personal computer 17 will ideally not receive a network address conflict message, and otherwise, if the supplied address conflicts with an address used by a client device, the personal computer 17 will receive a network address conflict message. In step S7135, it is determined whether the selected address is available, and, if so, the process proceeds to step S7137, and otherwise, to step S7131. In step S7135, the personal computer 17 receives no network address conflict message after a time-out expires, and determines that the selected address is available. Conversely, the personal computer 17 receives no network address conflict message after a time-out expires, and then retransmits the network address probe message (at most in finite retransmission times). After one or multiple retransmissions fail to receive any network address conflict messages, it is determined that the selected address is available by the personal computer 17. In step S7137, a network address announcement message comprising the selected address is broadcast to notify all server and client devices that the supplied address (i.e. A-address) is used to serve as its network address. The network address announcement message is preferably an ARP announcement message compatible with the ARP standard.

In step S7321, the network address probe message is received by the network address management server 11. In step S7323, the address allocation function is disabled. When the address allocation function is disabled, network address request messages transmitted from any client devices will be ignored (i.e. network address acknowledgement messages are not sent). In step S7325, a network address renew message is transmitted to the display apparatus 13 or mobile device 15 to force the display apparatus 13 or mobile device 15 to reacquire a new address to serve as its network address.

In step S7521, a network address renew message is received by the display apparatus 13 or mobile device 15. In step S7523, a network address request message is transmitted to the network address management server 11 to acquire a new address in the subnet 192.192.1.x. The network address request message is preferably a DHCPREQUEST message compatible with the DHCP standard. In step S7331, the network address request message is received by the network address management server 11. The received query message is ignored (i.e. do not reply a corresponding request acknowledgement message) because the address allocation function is previously disabled. In step S7531, it is determined whether the network address request is fail, and, if so, the process proceeds to step S7541. In step S7541, the display apparatus 13 or mobile device 15 receives no request acknowledgement message after a time-out expires, and then determines that the network address request has failed. Conversely, the display apparatus 13 or mobile device 15 receives no request acknowledgement message after a time-out expires, and then retransmits the network address request message (at most in finite retransmission times). After one or multiple retransmissions fail to receive any request acknowledgement messages, it is determined that the network address request has failed by the display apparatus 13 or mobile device 15.

An automatic address configuration procedure proceeding from steps S7541 to S7547 is performed by the display apparatus 13 or mobile device 15. In step S7541, an address in the subnet 203.62.x.x (i.e. A-address), preferably an Internet Protocol (IP) address, is randomly selected by the display apparatus 13 or mobile device 15. In step S7543, a network address probe message comprising the selected address is broadcast to ask whether the supplied address conflicts with an address used by a client device. The display apparatus 13 or mobile device 15 will ideally receive no network address conflict message, and otherwise, if the supplied address conflicts with an address used by a client device, the display apparatus 13 or mobile device 15 will receive a network address conflict message. In step S7545, it is determined whether the selected address is available, and, if so, the process proceeds to step S7547, and otherwise, to step S7541. In step S7545, the display apparatus 13 or mobile device 15 receives no network address conflict message after a time-out expires, and then determines that the selected address is available. Conversely, the display apparatus 13 or mobile device 15 receives no network address conflict message after a time-out expires, and then retransmits the network address probe message (at most in finite retransmission times). After one or multiple retransmissions fail to receive any network address conflict messages, it is determined that the selected address is available by the display apparatus 13 or mobile device 15. In step S7547, a network address announcement message comprising the selected address is broadcast to notify all server and client devices that the supplied address (i.e. A-address) is used to serve as its network address.

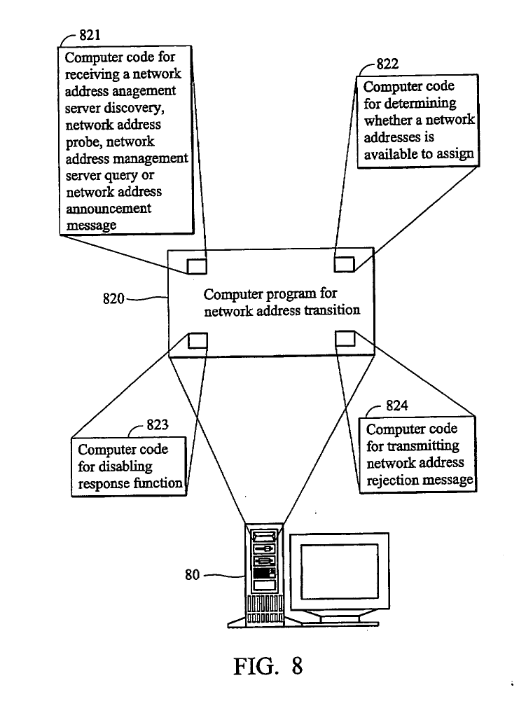

Also disclosed is a storage medium as shown in FIG. 8 storing a computer program 820 providing the disclosed methods of network address transition. The computer program includes a storage medium 80 having computer readable program code therein for use in a computer system. The computer readable program code comprises at least computer readable program code 821 receiving a network address management server discovery, network address probe, network address management server query or network address announcement message, computer readable program code 822 determining whether a network addresses is available, computer readable program code 823 disabling response function, and computer readable program code 824 transmitting network address rejection message.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system, MS, PDA, MSC, SMSC and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

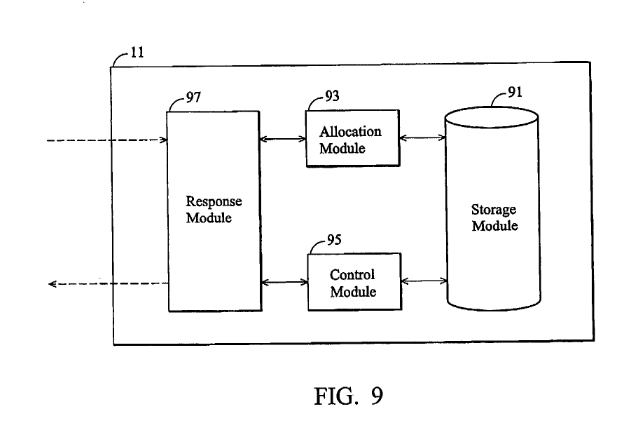

FIG. 9 is a diagram of software modules applicable in an embodiment of a network address management server 11. Network addresses in two subnets, such as 192.192.1.x and 203.62.x.x, can be configured as client device addresses. The network address management server 11 assigns stored addresses in the subnet 192.192.1.x to client devices, such as the display apparatus 13, mobile device 15 or personal computer 17, which attempt to connect to the network. The display apparatus 13 or mobile device 15 has acquired an address in the subnet 192.192.1.x (i.e. D-address) as its network address. The personal computer 17 initiates a network function to connect to the network and attempts to acquire an available address as its network address.

The network address management server 11 comprises a storage module 91, an allocation module 93, a control module 95 and a response module 97. The storage module 91 stores addresses in the subnet 192.192.1.x. The allocation module 93 assigns an address in the subnet 192.192.1.x to the display apparatus 13, mobile device 15 or personal computer 17. The response module 97 receives and replies with messages transmitted from the display apparatus 13, mobile device 15 or personal computer 17. The control module 95 receives a network address probe message from the personal computer 17, and, when the address in the subnet 192.192.1.x is not available, disables functions of the response module 97, thereby directing communications of the display apparatus 13, mobile device 15 or personal computer 17 using addresses in the subnet 203.62.x.x.

The control module 93 may assign an address in the subnet 192.192.1.x to the display apparatus 13, mobile device 15 or personal computer 17 connecting to the network. The control module 93 may simultaneously query the display apparatus 13, mobile device 15 and personal computer 17 after receiving a server discovery message, and, reclaims addresses used by those devices which do not reply with responses after a predetermined period of time. The server discovery message is utilized to detect whether a network address management server is present. The control module 93 may ignore the server discovery message or reply with a discovery rejection message. The network address probe message may be transmitted by the personal computer 17 during an automatic address configuration procedure. The automatic address configuration procedure may be activated after the personal computer 17 transmits the server discovery message and does not receive any server offer messages for a period of time.

The control module 93 may transmit a network address renew message to the display apparatus 13, mobile device 15 or personal computer 17. The network address message is utilized to force the display apparatus 13, mobile device 15 or personal computer 17 to reacquire an address in the subnet 192.192.1.x.

When the display apparatus 13, mobile device 15 or personal computer 17 does not receive any response from the control module 93, it transmits a network address probe message. The network address probe message comprises an address in the subnet 203.62.x.x. The control module 93 may receive the network address probe message.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method of network address transition, performed by a server assigning a plurality of addresses in a first subnet to a plurality of first electronic devices to serve as their network addresses, the first electronic devices and a second electronic device storing a plurality of addresses in a second subnet, comprising:
receiving a first network address probe message from the second electronic device recently connecting to a network, the first network address probe message comprising information regarding the second electronic device attempting to select an address in the second subnet to serve as its network address; and
disabling a response function utilized to reply to a request message from one of the plurality of first electronic devices.

2. The method as claimed in claim 1 wherein the request message is a server discovery message utilized to detect whether a network address management server is present, a network address request message utilized to acquire a new address in the first subnet, or a network address management server query message utilized to detect whether the server is available.

3. The method as claimed in claim 2 wherein the server discovery message is a DHCPDISCOVERY message compatible with the dynamic host configuration protocol (DHCP) standard, the network address request message is a DHCPQUEST message compatible with the DHCP standard, and the network address management server query message is a DHCPINFO message compatible with the DHCP standard.

4. The method as claimed in claim 1 comprising receiving a server discovery message in the second electronic device, the server discovery message utilized to detect whether a network address management server is present.

5. The method as claimed in claim 4 wherein the server stores the addresses in the first subnet, and the method further comprises:
assigning the address in the first subnet to the first electronic devices;
querying all first electronic devices after receiving the server discovery message; and
reclaiming a portion of the addresses in the first subnet used by a portion of first electronic devices which do not respond to queries.

6. The method as claimed in claim 4 wherein the server stores the addresses in the fist subnet, and the method further comprises:
assigning the addresses in the first subnet to the first electronic devices;
determining that no available address in the first subnet can be assigned to the second electronic device; and
ignoring the server discovery message or replying with a discovery rejection message utilized rejecting the server discovery message.

7. The method as claimed in claim 6 wherein the server discovery message is a DHCPNAK message compatible with the DHCP standard.

8. The method as claimed in claim 6 wherein the first network address probe message is transmitted during an automatic address configuration procedure performed by the second electronic device, and the automatic address configuration procedure is activated after the second electronic device transmits the server discovery message and does not receive any server offer messages for a period of time.

9. The method as claimed in claim 1 further comprising transmitting a plurality of network address renew messages to the first electronic devices, wherein the network address renew messages are utilized to force the first electronic devices to acquire new addresses in the first subnet.

10. The method as claimed in claim 1 further comprising receiving a second network address probe message comprising information regarding one of the first electronic devices attempting to select an address in the second subnet as its network address, wherein the second network address probe message is transmitted from one of the first electronic device when the server does not reply to the request message.

11. The method as claimed in claim 1 wherein the server is a dynamic host configuration protocol (DHCP) server.

12. The method as claimed in claim 1 wherein the network address probe message is an address resolution protocol (ARP) probe message compatible with the ARP standard.

13. A machine-readable storage medium for storing a computer program which, when executed by a server, performs a method of network address transition, the server directing a first electronic device originally using an address in a first subnet as its network address to convert the network address to an address in a second subnet, the method comprising:
disabling a response function after receiving a network address probe message comprising an address in the second subnet from a second electronic device recently connecting to network, enabling it to ignore a request message transmitted form the first electronic device,
wherein the network address probe message comprises information regarding asking whether the address in the second subnet therein conflicts with an address currently used by any of the other electronic devices.

14. A server connecting to a plurality of first electronic devices and a second electronic device via a network, the first electronic devices and the second electronic device storing a plurality of addresses in a second subnet, the server comprising:
a storage module storing a plurality of addresses in a first subnet;
an allocation module assigning the stored addresses in the first subnet to the first electronic devices as their network addresses;
a response module replying to messages from one of the first electronic devices and second electronic device; and
a control module receiving a first network address probe message from the second electronic device, and, when there is no available address in the first subnet stored in the storage module, disabling the response module, thereby directing communications between the first electronic devices and the second electronic device using addresses in the second subnet.

15. The server as claimed in claim 11 wherein the second electronic device transmits a server discovery message utilized to detect whether a network address management server is present.

16. The server as claimed in claim 15 wherein the control module assigns the addresses in the first subnet to the first electronic devices, queries all first electronic devices after receiving the server discovery message, and reclaims a portion of the addresses in the first subnet used by a portion of first electronic devices which do not respond to queries.

17. The server as claimed in claim 15 wherein the control module ignores the server discovery message or replies with a discovery rejection message.

18. The server as claimed in claim 15 wherein the first network address probe message is transmitted during an automatic address configuration procedure performed by the second electronic device, and the automatic address configuration procedure is activated after the second electronic device transmits the server discovery message and does not receive any server offer messages for a period of time.

19. The server as claimed in claim 14 wherein the control module transmitting a plurality of network address renew messages to the first electronic devices, the network address renew messages are utilized to force the first electronic devices to acquire new addresses in the first subnet as their network addresses.

20. The server as claimed in claim 14 wherein the control module receives a second network address probe message comprising information regarding one of the first electronic devices attempting to select an address in the second subnet to serve as its network address, and the second network address probe message is transmitted from one of the first electronic devices when the server does not reply to the request message.
